(19) United States
(12) Patent Application Publication
(10) Pub. No.: US 2017/0136642 A1
(43) Pub. Date: May 18, 2017

(54) METHOD AND DEVICE FOR ALTERNATELY CUTTING OFF MATERIAL BY BACK-AND-FORTH MOVEMENT OF MULTIPLE VEHICLES

(71) Applicant: Dalian Field Heavy Machinery Manufacturing Co., Ltd., Dalian (CN)

(72) Inventor: Guowo Gao, Dalian (CN)

(21) Appl. No.: 15/412,195

(22) Filed: Jan. 23, 2017

Related U.S. Application Data
(63) Continuation of application No. PCT/CN2014/085702, filed on Sep. 2, 2014.

(30) Foreign Application Priority Data
Jul. 23, 2014 (CN) 201410353425.0

(51) Int. Cl. B26D 1/60

(52) U.S. Cl. CPC B26D 1/60

(57) ABSTRACT

A method and device provides for alternately cutting off material by back-and-forth movement of multiple vehicles. Specifically, the device is a cut-off machine for alternately cutting off material by back-and-forth movement of multiple vehicles. The cut-off machine is at least provided with two cutter vehicles, wherein these vehicles are installed on tracks parallel to material. The tracks are arranged around the material side by side. Each vehicle moves back and forth in accordance with a set sequence. Cutters on the vehicles alternately cut off the material in accordance by a set length. The larger the number of vehicles, the longer the possible stroke of each vehicle can be, such that the cutters have more time to cut off the material. Accordingly, the cut-off machine can be adapted to higher material forming speeds in a production line.

### REFERENCE TO RELATED APPLICATION

This application is a continuation of PCT application number PCT/CN2014/085702 filed on Sep. 2, 2014, which is entitled “NOVEL METHOD AND DEVICE FOR ALTERNATELY CUTTING OFF MATERIAL BY BACK-AND-FORTH MOVEMENT OF MULTIPLE VEHICLES”, which claims priority to Chinese patent application number 201410353425.0 2014 filed on Jul. 23, 2014, the contents of which are hereby incorporated in their entireties.

### FIELD

The present disclosure relates to a method and apparatus for cutting material in a production line of high-speed continuously formed material. More particularly, a method and apparatus are provided for cutting off the material by a set length via multiple carriages configured to sequentially reciprocate.

### BACKGROUND

In a production line of high-speed continuously formed material, conventional cut-off machines are generally equipped with a single reciprocating carriage, whereby the carriage is equipped with a cutter. When the material travels a desired length, the carriage starts from an origination point and chases after the material. When the speed of the carriage matches the speed of the material, the cutter on the carriage cuts off the material in a direction perpendicular to the direction of travel of the material. The carriage then returns to the origination point for the next cutting operation.

The return of the carriage to the origination point typically utilizes valuable time that could otherwise be utilized for cutting. As such, the traveling distance of the carriage for conventional cut-off machines is typically short. Otherwise, in the time taken for the carriage to cut off the material and return to the origination point, the length which the material travels may exceed the desired length, thus interfering with subsequent cuttings of the material at the desired length.

Since the traveling distance of the carriage is typically short, the time for cutting the material is likewise short. When the cutter does not have sufficient cutting time, such as when the production line forms the material at a high speed, the cutter of the cut-off machine will often be forced to cut through the material at a faster pace, thus potentially damaging the cutter prematurely due to such forcible cutting. Thus, such conventional cutting machines are not typically suitable for a production line configured for high-speed continuously formed material.

### SUMMARY

In order to overcome the shortcomings in the conventional technology, the present disclosure provides a novel method and apparatus for cutting off material utilizing multiple carriages that are configured to sequentially reciprocate. A cut-off machine is thus provided for alternately cutting off material via multiple carriages configured for reciprocating movement. The cut-off machine, for example, has at least two carriages, wherein each carriage is respectively equipped with a cutter. The at least two carriages are mounted on rails in parallel with the direction of travel of the material, whereby the rails are arranged side-by-side around the material. The at least two carriages are configured to reciprocate in parallel to the direction of material travel on their respective rails in a predetermined sequence via respective driving devices. The cutters on the at least two carriages alternately cut off the material by a set length.

In accordance with one exemplary aspect, the cut-off machine is provided for alternately cutting off material via double carriages having reciprocating movement, whereby the time for the carriage to return to its origin point does not occupy the cutting time. Thus, the presently disclosed cut-off machine permits the carriage to have a long traveling distance, which, in theory, the traveling distance of the carriages may reach a the predetermined length of material to be cut. Due to the long traveling distance, the cutter may have more time cut material, even if the production line forming the material speeds up (e.g., the speed of formation of the material is increased). As long as the increased speed is maintained within a certain limit, the cutter of the present disclosure will have sufficient time cut off the material in the predetermined length. Accordingly, the cut-off machine for alternately cutting off material by double carriages having reciprocating movement can meet increased production needs for cutting off material by a set length in a production line of high-speed forming material.

In accordance with another exemplary aspect, the cut-off machine is configured for alternately cutting off material with more than two carriages having reciprocating movement, whereby such a cut-off machine has a similar working principle as the above cut-off machine for alternately cutting off material via double carriages having reciprocating movement. Such a cut-off machine for alternately cutting off material with two or more carriages has at least two carriages having reciprocating movement, where each of the two or more carriages is equipped respectively with a cutter, and wherein the two or more carriages are respectively mounted on rails in parallel with material, where the rails are arranged on opposing sides of the material. The two or more carriages reciprocate in a set sequence on their respective rails in parallel with the travel of the material via respective driving devices, whereby the cutters on the carriages alternately cut off the material by the set length. The present disclosure contemplates that a larger number of carriages can provide a longer traveling distance for each carriage, thus providing more time for the cutters to cut through the material. Therefore, higher material forming speeds can be attained in a production line utilizing the cut-off machine of the present disclosure. Theoretically, a distance of the cut-off machine may reach a maximum traveling distance that is equal to the total number of carriages minus one, multiplied by the set length of the material that is cut.

### BRIEF DESCRIPTION OF THE DRAWINGS

FIG. 1 is a schematic view illustrating a first carriage at an original point and a second carriage at a terminal point according to an example of the present disclosure.

FIG. 2 is a schematic view illustrating the first carriage running after a material and cutting the material according to an example of the present disclosure.

FIG. 3 is a schematic view illustrating the second carriage at the original point and the first carriage at the terminal point according to an example of the present disclosure.

FIG. 4 is a schematic view illustrating the second carriage running after the material and cutting the material according to an example of the present disclosure.

FIG. 5 is a schematic view showing a view along the direction of travel of the material of FIG. 2.

FIG. 6 is a schematic view showing a view along the direction of travel of the material of FIG. 4.

### DETAILED DESCRIPTION

Various embodiments of the present disclosure are further described hereinafter with reference to one of multiple forms of a cut-off machine for alternately cutting off a material with multiple carriages having reciprocating movement, whereby the cut-off machine alternately cut material via double carriages having reciprocating movement.

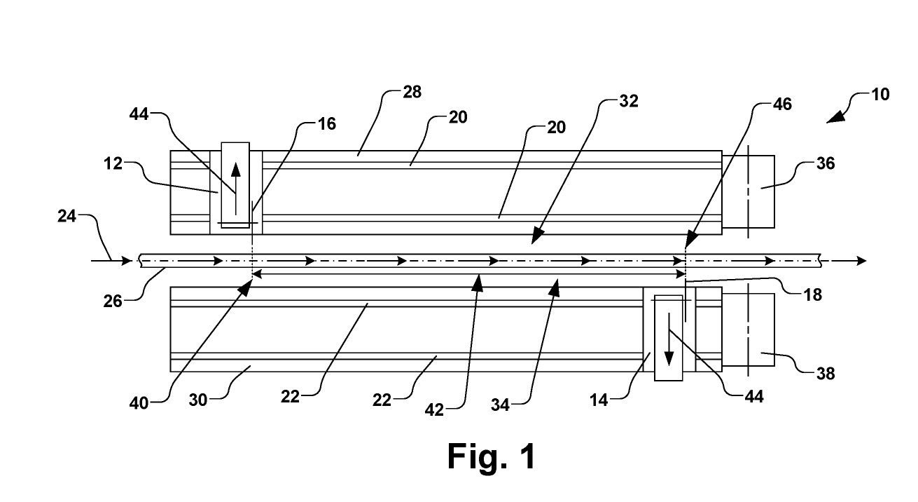

FIG. 1 illustrates an exemplary cut-off apparatus 10 in accordance with various aspects of the present disclosure. In accordance with one exemplary aspect of the disclosure, the cut-off machine 10 comprises a first carriage 12 and a second carriage 14. The first carriage 12, for example, comprises a first cutter 16, and the second carriage 14 comprises a second cutter 18. The first carriage 10 is mounted on a first rail 20, and the second carriage 14 is mounted on a second rail 22, whereby the respective first and second rails are generally parallel to a direction of travel 24 of a material 26. The first rail 20, for example, is coupled to a first base 28, and the second rail 22 is coupled to a second base 30. In the present example, the first base 28 and second base 30 are positioned below the respective first rail 20 and second rail 22. The first rail 20 and second rail 22, for example, are further respectively arranged on a first side 32 and a second side 34 of the material 26.

The first carriage 12 and second carriage 14, for example, are configured to individually reciprocate in a predetermined manner via respective first driving device 36 and second driving device 38. The cut-off apparatus 10, for example, is configured to alternately cut off the material 26 in predetermined lengths via reciprocal movement of the first carriage 12 and second carriage 14 with respect to the direction of travel 24 of the material 26, as will be discussed in further detail infra.

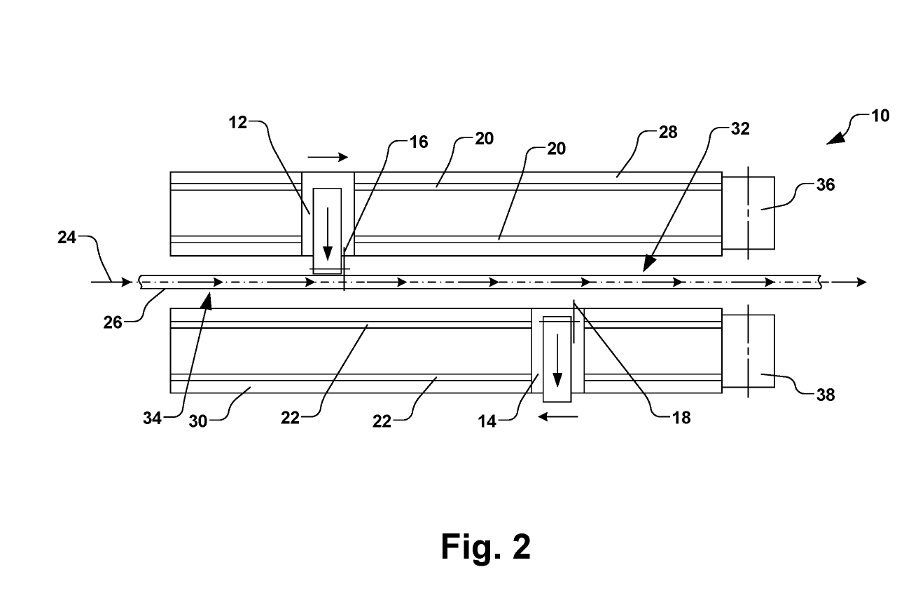

In order to gain a better understanding of the present disclosure, an exemplary operation of the cut-off apparatus 10 will be further described hereafter, whereby the cut-off apparatus alternately cuts the material in a sequential manner via the reciprocating movement of the first carriage 12 and second carriage 14. An example working cycle of the cut-off machine 10 will now be discussed. In a continuous forming process of the material 26, the first carriage 12 is stationed at an origin position 40 and begins to acclereate and travel via the first driving device 36 when the material 26 has travelled by a predetermined amount. When the speed of the first carriage 12 is same as the speed of the material 26, the first cutter 16 on the first carriage 12 cuts off a predetermined length 42 of the material by passing through the material in a direction 44 perpendicular to direction of travel 24 of the material, as illustrated in FIGS. 2 and 5. Once the material 26 is cut through, the first carriage 12 then stops at a terminal position 46.

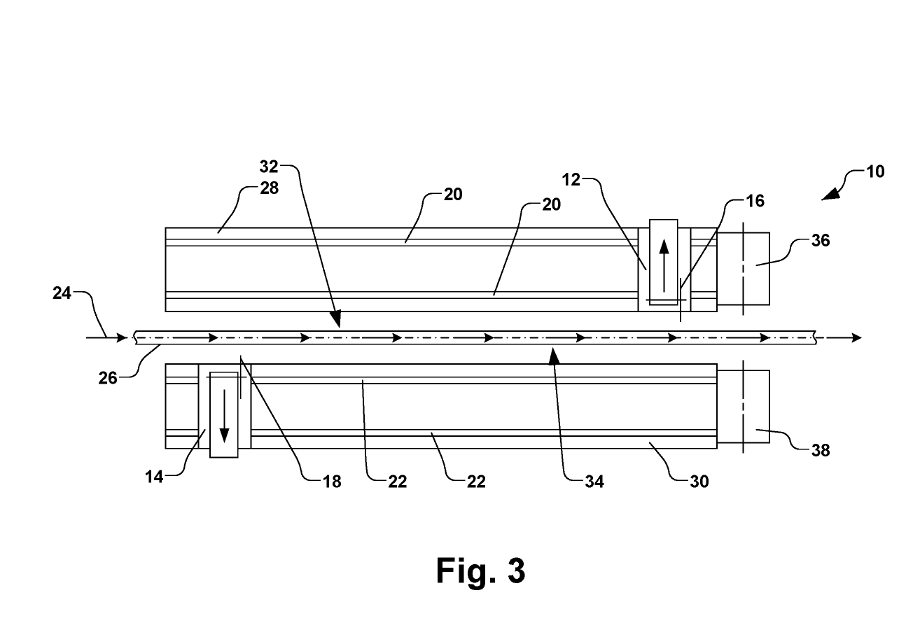

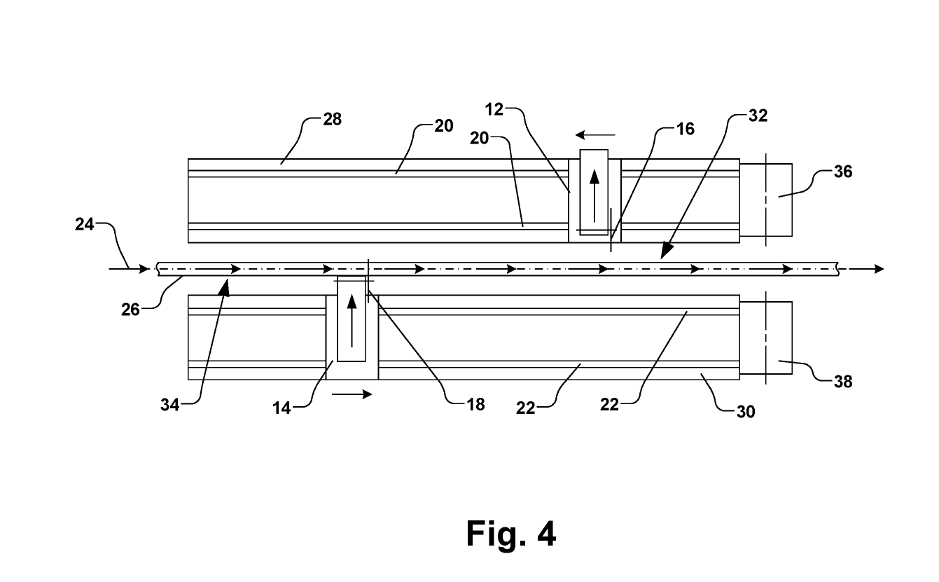

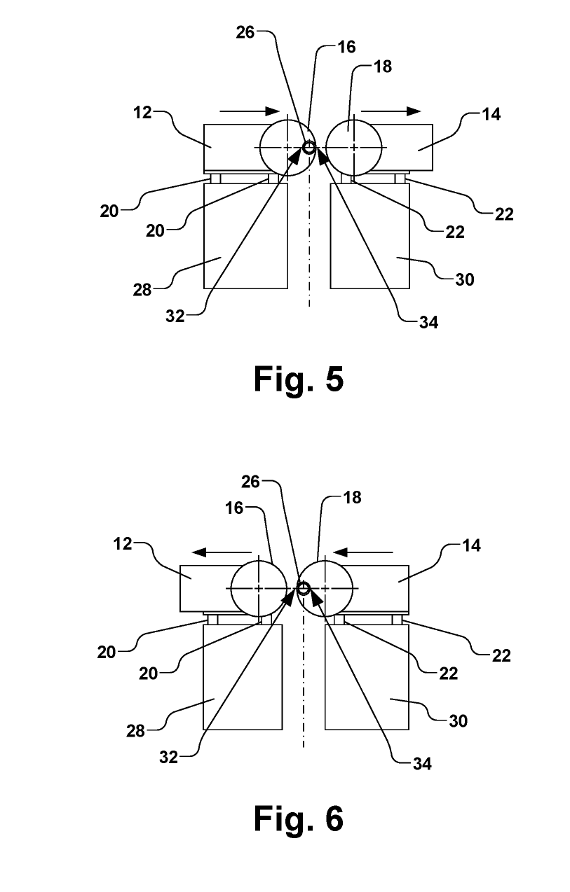

Meanwhile, the second carriage 14 travels to the origin position from the terminal position, and returns and stops at the origin position 40, as illustrated in FIG. 3. When the material 26 travels the predetermined amount again, the second carriage 14 begins to accelerate and travel via the second driving device 38. When the speed of the second carriage 14 is same with the speed of the material 26, the second cutter 18 on the second carriage 14 cuts off the predetermined length 42 of the material by reciprocally passing through the material in the direction 44 perpendicular to the direction of travel 24 of the material, as illustrated in FIGS. 4 and 6. The second carriage 14 then stops at the terminal position 46. Meanwhile, the first carriage 12 returns from the terminal position 46, and stops again the origin position 40, as shown again in FIG. 1. As long as the material 26 is formed continuously on the production line, the cut-off machine 10 may ceaselessly repeat the above working cycle.

Thus, the cut-off machine 10 is configured for alternately cutting off material 26 by double carriages (comprising the first carriage 12 and second carriage 14) having reciprocating movement. The first carriage 12 and the second carriage 14 are both mounted on their respective first and second rails 20, 22 in parallel with the material 26, whereby the first and second rails are arranged around the material side-by-side, and wherein the first carriage and the second carriage reciprocate in a set sequence by via respective first and second driving devices 36, 38, respectively. The first carriage 12 and the second carriage 14 are respectively equipped with the first and second cutters 16, 18, and are configured to travel on the first and second rails 20, 22 in parallel with the travel 24 of the material 26 between the origin position 40 and the terminal position 46.

When the material 26 travels the predetermined length 42, the first driving device 36 starts and allows the first carriage 12 to accelerate from the origin position 40. When the speed of the first carriage 12 is same with the speed of the material 26, the first cutter 16 on the first carriage 12 begins to cut off the material 26 in the direction 44 perpendicular to the direction of travel 24 of the material 26, as illustrated in FIG. 2, and then stops at the terminal position 46 when the material is cut through. Meanwhile, the second carriage 14 returns to the origin position 40 from the terminal position 46, and then stops, as illustrated in FIG. 3. When the material 26 travels by the predetermined length 42 again, the second driving device 38 starts and allows the second carriage 14 to acclerate from the origin position 40. When the speed of the second carriage 14 is the same as the speed of the material 26, the second cutter 18 on the second carriage cuts off the predetermined length 42 of the material 26 by passing through the material in the direction 44 perpendicular to the travel 24 of the material, as illustrated in FIG. 4, and then stops at the terminal position 46. Meanwhile, the first carriage 12 again returns to the origin position 40 from the terminal position 46 and then stops, as illustrated again in FIG. 1. The cut-off machine 10 can then repeat the above working cycle over and over, repeatedly cutting off the material 26 by the predetermined length 42.

The cut-off machine is thus provided for alternately cutting off material via at least two carriages having reciprocating movement, where each of the at least two carriages are respectively equipped with a cutter. The at least two carriages are respectively mounted on rails in parallel with the material, whereby the rails are arranged around the material side-by-side. Each of the at least two carriages reciprocates in a set sequence, whereby the respective cutters on the carriages alternately cut off the material by a set length. The greater the number of carriages, for example, the longer the traveling distance for each carriage can be set, thus providing a greater amount of time for the cutters to cut off the material. Accordingly, the forming speed for the material may be advantageously increased in a production line utilizing the cut-off machine of the present disclosure. Thus, the present disclosure contemplates two or more carriages, whereby in theory, a maximum traveling distance of the carriages is generally equal to the number of carriages minus one, multiplied by the predetermined length of material to be cut.

What is claimed is:

1. A method for repeatedly cutting a high-speed continuously-formed flow of material, the method comprising the acts of:
(a) translating a first carriage from an origin position toward a terminal position once the material travels a predetermined length in a travel direction;
(b) cutting through the material via a first cutter on the first carriage, whereby the material is cut through in a first direction perpendicular to the travel direction when a speed of the first carriage is the same as a speed of the flow of the material;
(c) stopping the first carriage at the terminal position after the first cutter cuts through the material, and concurrently translating a second carriage from the terminal position to the origin position;
(d) translating the second carriage from the origin position toward the terminal position once the material travels the predetermined length in the travel direction;
(e) cutting through the material via a second cutter on the second carriage, whereby the material is cut through in a second direction perpendicular to the travel direction when a speed of the second carriage is the same as the speed of the flow of the material;
(f) stopping the second carriage at the terminal position after the second cutter cuts through the material, and concurrently translating the first carriage from the terminal position to the origin position; and
repeating acts (a) through (f) as the material is continuously formed.

2. The method of claim 1, wherein the first cutter and second cutter are at the same location in the travel direction of the material when the respective first cutter and second cutter cuts through the material.

3. The method of claim 1, wherein the first carriage and second carriage translate an equal maximum distance.

4. The method of claim 1, further comprising:
(g) translating an additional carriage from the origin position toward the terminal position once the material travels the predetermined length in the travel direction;
(h) cutting through the material via an additional cutter on the additional carriage, whereby the material is cut through in an additional direction perpendicular to the travel direction when a speed of the additional carriage is the same as the speed of the flow of the material;
(i) stopping the additional carriage at the terminal position after the additional cutter cuts through the material, and concurrently translating one or more of the first carriage and second carriage from the terminal position to the origin position; and
wherein repeating acts (a) through (f) further includes repeating acts (g) through (i) as the material is continuously formed.

5. The method of claim 4, comprising a plurality of additional carriages, wherein acts (g) through (i) are performed for each of the plurality of additional carriages.

6. The method of claim 5, wherein the first carriage, second carriage, and each additional carriage translates an equal maximum distance.

7. The method of claim 6, wherein the maximum distance equals the number of additional carriages plus one, multiplied by the predetermined length.

8. The method of claim 1, wherein the first carriage is positioned on a first side of the material, and the second carriage is positioned on a second side of the material, wherein the first side and second side a generally opposed to one another.

9. The method of claim 1, wherein each of the first carriage and second carriage are mounted on respective rails that are parallel to the travel direction.

10. The method of claim 9, wherein the first carriage and second carriage are translated via a respective first driving device and second driving device.

11. An apparatus for repeatedly cutting a predetermined length from a high-speed continuously-formed flow of material that flows in a travel direction, the apparatus comprising:
a first carriage configured to translate between an origin position and a terminal position;
a first cutter operably coupled to the first carriage, wherein the first cutter is configured to cut through the material in a first direction perpendicular to the travel direction when a speed of the first carriage is the same as a speed of the flow of the material;
a second carriage configured to translate between the origin position and the terminal position; and
a second cutter operably coupled to the second carriage, wherein the second cutter is configured to cut through the material in a second direction perpendicular to the travel direction when a speed of the second carriage is the same as a speed of the flow of the material.

12. The apparatus of claim 11, wherein the first carriage is positioned on a first side of the material, and the second carriage is positioned on a second side of the material, wherein the first side and second side a generally opposed to one another.

13. The apparatus of claim 11, wherein each of the first carriage and second carriage are mounted on respective rails that are parallel to the travel direction.

14. The apparatus of claim 13, further comprising:
a first driving device configured to translate the first carriage; and
a second driving device configured to translate the second carriage.
